(19) United States
(12) Patent Application Publication
(10) Pub. No.: US 2023/0341070 A1
(43) Pub. Date: Oct. 26, 2023

(54) TAPERED THREAD CONNECTION SEALING ARRANGEMENTS

(71) Applicant: Swagelok Company, Solon, OH (US)

(72) Inventors: Vyatseslav Lozitsky, Parma, OH (US); Thomas Lippucci, Seven Hills, OH (US)

(21) Appl. No.: 18/042,605

(22) PCT Filed: Nov. 3, 2021
(86) PCT No.: PCT/US2021/057811

§ 371 Date: Feb. 23, 2023

Related U.S. Application Data
(60) Provisional application No. 63/110,383, filed on Nov. 6, 2020.

(51) Int. Cl. F16L 15/00

(52) U.S. Cl. CPC F16L 15/003

(57) ABSTRACT

A fitting assembly includes a first component having a metal male threaded port including a male tapered threaded portion and an end face and a second component having a metal female threaded port including a female tapered threaded portion and a counterbore, the female threaded port threadably receiving the male threaded port. An apertured metal insert is disposed between the end face and the counterbore and includes first and second seal surfaces. When the first component is tightened with the second component, the metal insert is engaged between the end face and the counterbore, such that the first seal surface seals against the end face and the second seal surface seals against the counterbore, to provide a metal-to-metal seal between the male threaded port and the female threaded port.

### CROSS-REFERENCE TO RELATED APPLICATION

This application claims priority to and all benefit of U.S. Provisional Patent Application Ser. No. 63/110,383, filed on Nov. 6, 2020, for TAPERED THREAD CONNECTION SEALING ARRANGEMENTS, the entire disclosure of which is fully incorporated herein by reference.

### TECHNICAL FIELD

The present disclosure relates to tapered thread connections. More particularly, the disclosure relates to sealing arrangements for tapered thread connections.

### SUMMARY OF THE DISCLOSURE

In accordance with an exemplary aspect of one or more of the inventions presented in this disclosure, a fitting assembly includes a first component having a metal male threaded port including a male tapered threaded portion and an end face and a second component having a metal female threaded port including a female tapered threaded portion and a counterbore, the female threaded port threadably receiving the male threaded port. An apertured metal insert is disposed between the end face and the counterbore and includes first and second seal surfaces. When the first component is tightened with the second component, the metal insert is engaged between the end face and the counterbore, such that the first seal surface seals against the end face and the second seal surface seals against the counterbore, to provide a metal-to-metal seal between the male threaded port and the female threaded port.

In accordance with another exemplary aspect of one or more of the inventions presented in this disclosure, a fitting assembly includes a first component having a metal male threaded port including a male tapered threaded portion and a sealing extension extending from the male tapered threaded portion to an end face, and a second component having a metal female threaded port including a female tapered threaded portion and a counterbore, the female threaded port threadably receiving the male threaded port. When the first component is tightened with the second component, the end face of the male threaded port seals against the counterbore of the female threaded port to provide a metal-to-metal seal between the male threaded port and the female threaded port.

### BRIEF DESCRIPTION OF THE DRAWINGS

FIG. 1 is a cross-sectional view of a tapered thread connection assembly including a metal-to-metal seal arrangement, in accordance with an exemplary embodiment of the present disclosure;

FIG. 1A is an enlarged cross-sectional partial view of the metal-to-metal seal arrangement of the tapered thread connection assembly of FIG. 1;

FIG. 1B is a side cross-sectional view of the metal seal insert of the tapered thread connection assembly of FIG. 1;

FIG. 2 is a cross-sectional view of a metal seal insert for a tapered thread connection assembly, in accordance with another exemplary embodiment of the present disclosure;

FIG. 3 is a cross-sectional view of a tapered thread connection assembly including a metal-to-metal seal arrangement, in accordance with another exemplary embodiment of the present disclosure;

FIG. 3A is an enlarged cross-sectional partial view of the metal-to-metal seal arrangement of the tapered thread connection assembly of FIG. 3; and

FIG. 4 is a cross-sectional view of a male threaded port for a tapered thread connection assembly, in accordance with another exemplary embodiment of the present disclosure.

### DESCRIPTION OF THE EXEMPLARY EMBODIMENTS

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Tapered threaded connections for fluid system components, such as, for example, American National Pipe Tapered (NPT) threads are typically relied on to provide both a mechanical joint and a fluid-tight seal at the joint thread connection. To facilitate assembly to a leak tight connection, a thread sealant, such as, for example, polytetrafluoroethylene (PTFE) tape or a liquid thread sealant (e.g., pipe dope) is often used. In some applications, including, for example, use at extremely high temperatures (e.g., greater than about 450° F.), a leak tight seal at the threaded connection may be difficult to achieve. In some such arrangements, a conventional approach is to provide a weld (e.g., seal weld or back-weld) at the threaded connection. Still other applications do not allow for wetted thread connections, for example, due to undesirability of fluid trapped in the threaded region.

According to an exemplary aspect of the present disclosure, a tapered thread (e.g., NPT) connection (e.g., end connector with male NPT port and valve body with female NPT port) may be provided with an apertured metal insert sized to be received between a counterbore of the female tapered thread port and an end face of the male tapered thread port. When the male tapered thread port is assembled with the female tapered thread port, a first seal surface of the insert sealingly engages the male tapered thread port end face and a second seal surface of the insert sealingly engages the female tapered thread port counterbore, to provide a metal-to-metal seal between the threaded components, for example, independent of or instead of a seal at the mating tapered threads.

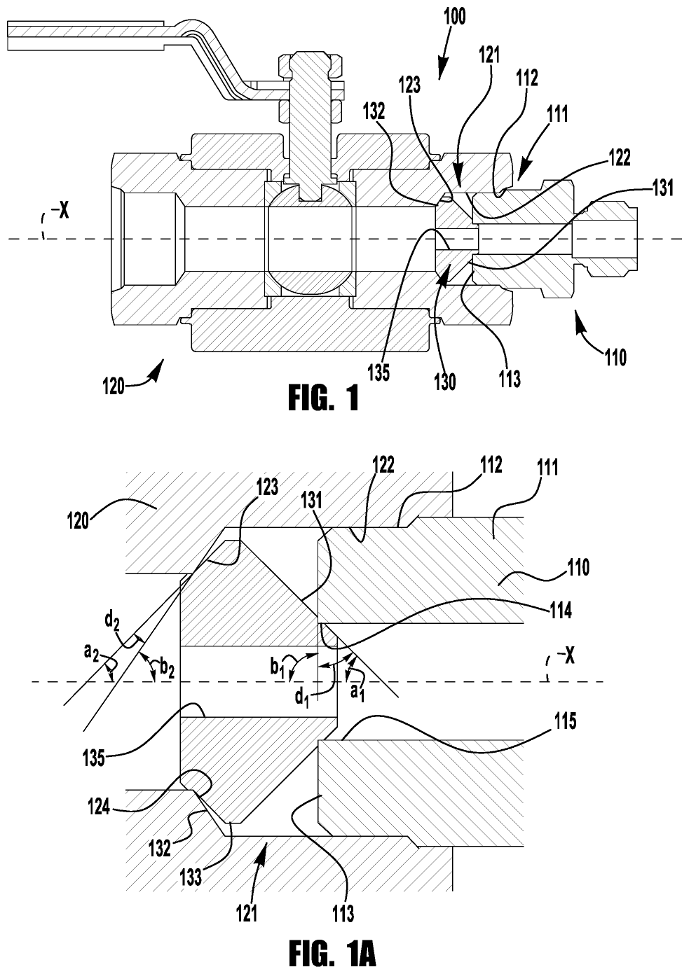

FIG. 1 illustrates an exemplary tapered thread assembly 100 including a first component 110 having a male threaded port 111 including a male threaded portion 112 and an end face 113 and a second component 120 having a female threaded port 121 including a female threaded portion 122 and a counterbore 123, and an apertured metal insert 130 including first and second seal surfaces 131, 132. When the first component 110 is tightened with, or pulled up on, the second component 120, the metal insert 130 is clamped, compressed, or otherwise engaged between the end face 113 and the counterbore 123, such that the first seal surface 131 seals against the end face and the second seal surface 132 seals against the counterbore, to provide a metal-to-metal seal between the threaded components 110, 120.

While the first and second seal surfaces 131, 132 may be provided with a variety of contours, in the illustrated embodiment, as shown in FIG. 1A, the first and second seal surfaces are tapered at angles a1, a2 (with respect to a central axis X of the connection) smaller than angles b1, b2 of the end face 113 and counterbore 123 (e.g., a difference angle d1, d2 of at least about 15°), such that a circumferential seal is provided at the inner diameter edges 114, 124 of the end face and counterbore. In an exemplary embodiment, the metal insert 130 includes a frustoconical first seal surface 131 extending at an angle a1 of between about 45° and about 70°, or about 55°, for sealing engagement with an inner diameter edge 114 of a male threaded port end face 113 that is substantially perpendicular to the central axis X (i.e., an angle b1 of about) 90°, and a frustoconical second seal surface 132 extending at an angle a2 of between about 40° and about 70°, or about 55°, for sealing engagement with an inner diameter edge 124 of a frustoconical female threaded port counterbore 122 extending at an angle b2 between about 55° and about 90°, or about 70°, with respect to the central axis X, selected, for example, to allow clearance with the second seal surface 132. As shown, the frustoconical seal surfaces 131, 132 of the exemplary insert 130 extend radially outward to an outer radial surface 133, which may be substantially cylindrical (as shown), convex, or any other suitable contour. The insert aperture or bore 135 may be smaller than the male threaded port bore 115, for example to minimize material deformation at the bores 115, 135.

Because the insert 130 provides a metal-to-metal seal between the first and second components 110, 120, the mating male and female threaded portions 112, 122 need not be relied on to provide a fluid tight seal, but still provide a mechanical joint between the first and second components configured to withstand forces applied by internal fluid pressure within the connection. To ensure adequate retention forces between the male and female threaded portions 112, 122, the insert 130 may be sized to provide sufficient threaded joint strength, taking into consideration, for example, material of construction and/or operating/design pressure and temperature. In one such exemplary embodiment, the insert 130 may be sized to permit threaded pull-up to at least about 85% of the wrench tight thread engagement of the threaded connection absent the metal insert, as defined in ASTM B1.20.1 for NPT threads. In another exemplary arrangement, as shown in FIG. 1B, the metal insert 130 may be sized such that component engaging locations 138, 139 on the first and second seal surfaces 131, 132 are separated by an axial distance L corresponding to an axial distance between the seal engaging inner diameters 118, 129 of the first and second components 110, 120 when the fitting pulled up a predetermined amount without the metal insert (e.g., an axial advance of about 0.010″ past finger-tight pull-up). As shown, the seal engaging inner diameters 118, 129 may be disposed on chamfered inner diameter edges of the first and second components, for example, up to a 0.010″ wide frustoconical (e.g., about 45°) chamfer, or a 0.010″ radiused edge break.

The insert 130 may be provided in a softer material than the male and female threaded ports 111, 121, for example, to provide a metal-to-metal seal while minimizing deformation of the end face 113 and counterbore 123. In an exemplary embodiment, a metal insert 130 is formed from a metal material having an equal or lesser hardness that a material of the male and female threaded ports 111, 121. In some such embodiments, the insert 130 is replaced with a new insert when the connection is disassembled and remade, for example, to replace a metal insert with sealing surfaces that have deformed to effect a metal-to-metal seal. In one such example, the insert is provided in solution annealed stainless steel for use with strain hardened stainless steel threaded ports.

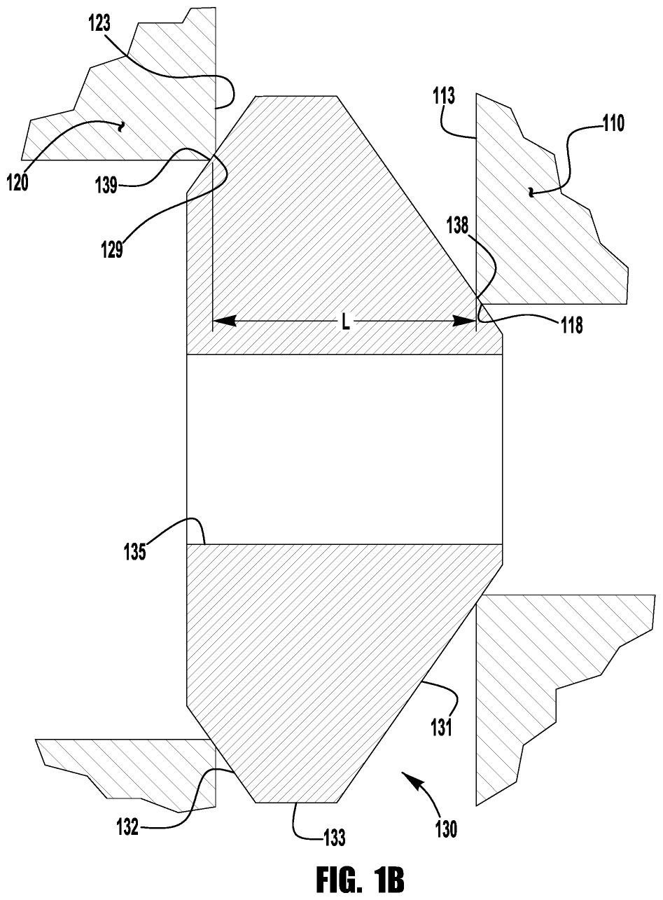

According to another exemplary aspect of the present disclosure, a sealing metal insert for a tapered thread connection may additionally or alternatively be provided with geometry configured to allow for elastic deflection under load of the insert to allow for thermal expansion/contraction during temperature changes while maintaining sealing load, by adjusting an axial distance between the first and second seal surfaces. As one example, as schematically shown in FIG. 2, a sealing metal insert 130a may include one or more outer circumferential notches 136a extending radially inward from the outer surface of the insert (e.g., the outer radial surface 133a), and/or one or more inner circumferential notches 137a extending radially outward from the internal aperture 134a of the insert. While the circumferential notches 136a, 137a are shown as being axially aligned with the outer radial surface 133a of the insert 130a, in other embodiments, one or more notches may be provided at other locations along the axial length of the insert, including, for example, along the tapered, sealing surface defining portions of the insert. In some such embodiments, the inclusion of multiple circumferential notches may tend to cause the insert to function like an elastically compressible bellows seal or stack of Belleville springs.

When the insert 130a is installed between the male threaded port end face and the female threaded port counterbore (e.g., similar to the assembly 100 of FIG. 1), thermal expansion of either or both of the components 110, 120 axially compresses the insert 130a at the notch(es) 136a, 137a (to reduce the axial distance between the first and second seal surfaces), and thermal contraction of either or both of the components 110, 120 allows for elastic axial expansion of the insert at the notch(es) (to reduce the axial distance between the first and second seal surfaces), to maintain sealing load. The depth, width, and number of notches 136a, 137a may be selected to provide a desired amount of elastic compressibility of the metal insert. In an exemplary embodiment, one outer circumferential notch is provided, having a depth between about 60% to about 90% of the cross-sectional wall thickness of the insert, adjacent to the notch.

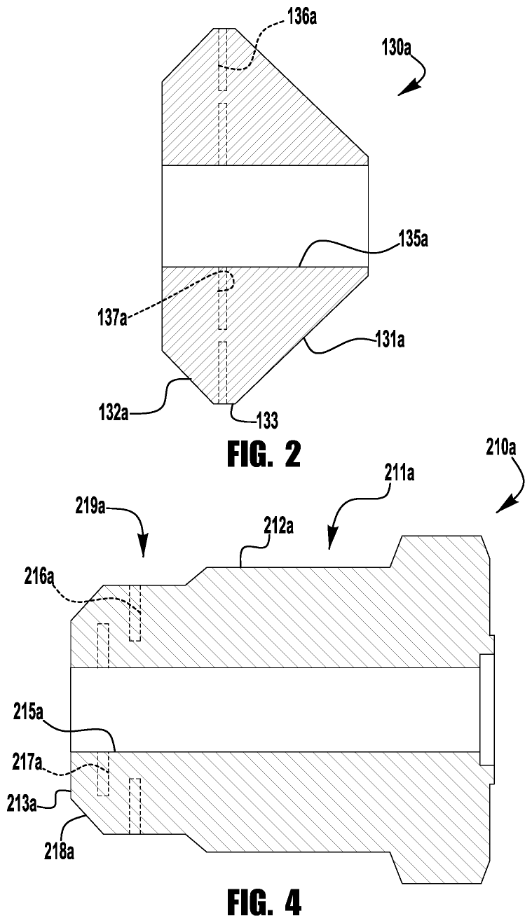

According to another exemplary aspect of the present disclosure, in other embodiments, a first component may be provided with a male threaded port having a sealing extension sized to engage a counterbore portion of a mating female threaded port of a second component. FIG. 3 illustrates an exemplary tapered thread assembly 200 including a first component 210 (e.g., end connector) having a male threaded port 211 including a male threaded portion 212 and a seal surface 218 (e.g., surrounding end face 213) disposed on a sealing extension 219 that extends from the male threaded portion, and a second component 220 (e.g., valve) having a female threaded port 221 including a female threaded portion 222 and a counterbore 223 that seals against the sealing extension seal surface 218 when the first component is tightened with or pulled up on the second component, to provide a metal-to-metal seal between the threaded components 210, 220.

While the sealing extension seal surface 218 may be provided with a variety of contours, in the illustrated embodiment, as shown in FIG. 3A, the sealing extension seal surface is tapered at an angle a3 (with respect to a central axis X of the connection) smaller than an angle b3 of the counterbore 222, such that a circumferential line seal is provided at the inner diameter edge 224 of the counterbore. In an exemplary embodiment, the sealing extension seal surface 218 includes a frustoconical first seal surface extending at an angle a3 of between about 40° and about 70°, or about 55°, for sealing engagement with an inner diameter edge 224 of a frustoconical female threaded port counterbore 222 extending at an angle b3 of about between about 55° and about 90°, or about 70° with respect to the central axis X, selected, for example, to allow clearance with the sealing extension seal surface 218.

Because the sealing extension 219 provides a metal-to-metal seal between the first and second components 210, 220, the mating male and female threaded portions 212, 222 need not be relied on to provide a fluid tight seal, but still provide a mechanical joint between the first and second components configured to withstand forces applied by internal fluid pressure within the connection. To ensure adequate retention forces between the male and female threaded portions 212, 222, the sealing extension 219 may be sized to provide sufficient threaded joint strength, taking into consideration, for example, material of construction and/or operating/design pressure and temperature. In one such exemplary embodiment, the insert 130 may be sized to permit threaded pull-up to at least about 85% of the wrench tight thread engagement of the threaded connection absent the metal insert, as defined in ASME B1.20.1 for NPT threads.

The sealing extension 219 may be provided in a softer material than the female threaded port 221, for example, to provide a metal-to-metal seal while minimizing deformation of the counterbore 222. In an exemplary embodiment, a sealing extension 219 is formed from a metal material having an equal or lesser hardness that a material of the female threaded port 221. In some such embodiments, the male threaded first component 210 is replaced with a new male threaded component when the connection is disassembled and remade, for example, to replace a metal component with sealing surfaces that have deformed to effect a metal-to-metal seal.

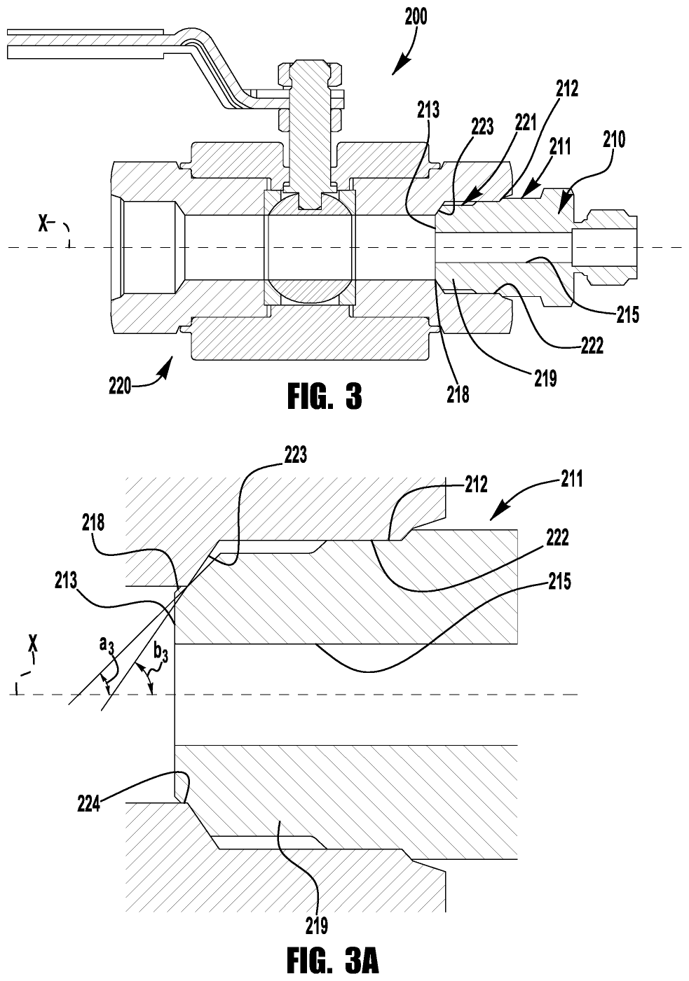

According to another exemplary aspect of the present disclosure, a sealing extension of a male threaded port may additionally or alternatively be provided with geometry configured to allow for elastic deflection under load of the extension to allow for thermal expansion/contraction during temperature changes while maintaining sealing load, by adjusting an axial length of the sealing extension. As one example, as schematically shown in FIG. 4, a first component 210a may include a male threaded port 211a with a sealing extension 219a having one or more outer circumferential notches 216a extending radially inward from the outer diameter surface(s), and/or one or more inner circumferential notches 217a extending radially outward from the internal bore 215a of the sealing extension. The circumferential notch(es) 216a, 217a may be provided at any suitable locations along the axial length of the insert. In some such embodiments, the inclusion of multiple circumferential notches may tend to cause the sealing extension to function like an elastically compressible bellows seal.

When the first and second components 210a, 220 are assembled to sealing engagement of the male threaded port seal surface 218a and the female threaded port counterbore 223, thermal expansion of either or both of the components 210a, 220 axially compresses the sealing extension 219a at the notch(es) 216a, 217a (to reduce the axial length of the sealing extension), and thermal contraction of either or both of the components 210a, 220 allows for elastic axial expansion of the sealing extension at the notch(es) (to increase the axial length of the sealing extension), to maintain sealing load. The depth, width, and number of notches 236a, 237a may be selected to provide a desired amount of elastic compressibility of the metal insert. In an exemplary embodiment, one outer circumferential notch is provided, having a depth between about 60% to about 90% of the cross-sectional wall thickness of the insert, adjacent to the notch.

While the sealing extension 219, 219a may be integrally formed with the first component 210, 210a, as shown in FIGS. 3, 3A, and 4, in other embodiments, a sealing extension may be welded (e.g., joint welded) to the end face of the first component, for example, to adapt a male threaded component to seal at the female threaded component counterbore independent of or instead of at the threads. The welded sealing extension may be provided with geometry configured to allow for elastic deflection under load of the extension to allow for thermal expansion/contraction during temperature changes while maintaining sealing load. For example, the sealing extension component may include ID and/or OD notches (as described above), or elastically flexible bellows portions, which may be more efficiently formed on a separate sealing extension component, as compared to integral formation of these features on a male threaded component.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A fitting assembly comprising:
a first component having a metal male threaded port including a male tapered threaded portion and an end face;
a second component having a metal female threaded port including a female tapered threaded portion and a counterbore, the female threaded port threadably receiving the male threaded port; and
an apertured metal insert disposed between the end face and the counterbore and including first and second seal surfaces;
wherein when the first component is tightened with the second component, the metal insert is engaged between the end face and the counterbore, such that the first seal surface seals against the end face and the second seal surface seals against the counterbore, to provide a metal-to-metal seal between the male threaded port and the female threaded port.

2. The fitting assembly of claim 1, wherein the first seal surface is tapered at an angle smaller than an angle of the end face, such that the first seal surface sealingly engages an inner diameter edge of the end face.

3. The fitting assembly of claim 1, wherein the second seal surface is tapered at an angle smaller than an angle of the counterbore, such that the second seal surface sealingly engages an inner diameter edge of the counterbore.

4. The fitting assembly of claim 1, wherein the first seal surface is a frustoconical surface extending at an angle of about 55° with respect to a central axis of the assembly.

5. The fitting assembly of claim 1, wherein the second seal surface is a frustoconical surface extending at an angle of about 55° with respect to a central axis of the assembly.

6. The fitting assembly of claim 1, wherein the metal insert is sized to permit at least about 85% thread engagement between the male and female tapered threaded portions.

7. The fitting assembly of claim 1, wherein the metal insert comprises at least one circumferential notch sized to permit elastic axial compression of the metal insert to adjust an axial distance between the first and second seal surfaces.

8. The fitting assembly of claim 7, wherein the at least one circumferential notch includes an outer circumferential notch extending radially inward from an outer surface of the metal insert.

9. The fitting assembly of claim 7, wherein the at least one circumferential notch includes an inner circumferential notch extending radially outward from an internal aperture of the metal insert.

10. The fitting assembly of claim 1, wherein one of the first and second components comprises an end connector and the other of the first and second components comprises a valve.

11. A fitting assembly comprising:
a first component having a metal male threaded port including a male tapered threaded portion and a sealing extension extending from the male tapered threaded portion to an end face; and
a second component having a metal female threaded port including a female tapered threaded portion and a counterbore, the female threaded port threadably receiving the male threaded port;
wherein when the first component is tightened with the second component, the end face of the male threaded port seals against the counterbore of the female threaded port to provide a metal-to-metal seal between the male threaded port and the female threaded port.

12. The fitting assembly of claim 11, wherein the end face is tapered at an angle smaller than an angle of the counterbore, such that the end face sealingly engages an inner diameter edge of the counterbore.

13. The fitting assembly of claim 11, wherein the end face includes a frustoconical sealing surface extending at an angle of about 55° with respect to a central axis of the assembly.

14. The fitting assembly of claim 11, wherein the counterbore is a frustoconical surface extending at an angle between about 55° and about 90° with respect to a central axis of the assembly.

15. The fitting assembly of claim 11, wherein the sealing extension is sized to permit at least about 85% thread engagement between the male and female tapered threaded portions.

16. The fitting assembly of claim 11, wherein the sealing extension comprises at least one circumferential notch sized to permit elastic axial compression of the sealing extension to adjust an axial distance between the first and second seal surfaces.

17. The fitting assembly of claim 16, wherein the at least one circumferential notch includes an outer circumferential notch extending radially inward from an outer surface of the sealing extension.

18. The fitting assembly of claim 16, wherein the at least one circumferential notch includes an inner circumferential notch extending radially outward from an internal bore of the sealing extension.

19. The fitting assembly of claim 11, wherein one of the first and second components comprises an end connector and the other of the first and second components comprises a valve.
